(19) United States
(12) Patent Application Publication
(10) Pub. No.: US 2024/0044059 A1
(43) Pub. Date: Feb. 8, 2024

(54) DEVICE FOR PRODUCING A COMPOSITE NONWOVEN WEB

(71) Applicant: ANDRITZ KUESTERS GMBH, KREFELD (DE)

(72) Inventors: HENNING VOMHOF, KOELN (DE); ANDREAS REITER, ARNSBERG (DE); DENNIS LATENDORF, KREFELD (DE)

(73) Assignee: ANDRITZ KUESTERS GMBH, KREFELD (DE)

(21) Appl. No.: 18/266,280

(22) PCT Filed: Dec. 13, 2021
(86) PCT No.: PCT/EP2021/085456

§ 371 Date: Jun. 9, 2023

(30) Foreign Application Priority Data
Dec. 22, 2020 (DE) 10 2020 134 721.9

(51) Int. Cl. D04H 13/00; B32B 5/02; B32B 5/26

(52) U.S. Cl. CPC D04H 13/002; B32B 5/022; B32B 5/267; D21F 1/02

(57) ABSTRACT

A device for producing a composite nonwoven web which includes a first layer and a second layer. The first layer has a spunbonded nonwoven and/or long fibers. The first layer has an upper face and a first width. The second layer has short fibers and a second width. The device includes at least one conveyor device which transports at least the first layer in a conveying direction, a headbox system which dispenses the short fibers onto the upper face of the first layer between two edges which extend transversely to the conveying direction, and a collecting device which is arranged so that some of the short fibers dispensed from the headbox system can be collected in a region of at least one of the two edges before the short fibers which are dispensed in the region come into contact with the upper face of the first layer.

### CROSS REFERENCE TO PRIOR APPLICATIONS

This application is a U.S. National Phase application under 35 U.S.C. § 371 of International Application No. PCT/EP2021/085456, filed on Dec. 13, 2021 and which claims benefit to German Patent Application No. 10 2020 134 721.9, filed on Dec. 22, 2020. The International Application was published in German on Jun. 30, 2022 as WO 2022/135995 A1 under PCT Article 21(2).

### FIELD

The present invention relates to a device for producing a composite nonwoven web with at least two layers, wherein the first layer comprises long fibers and the second layer comprises short fibers and has a second width.

### BACKGROUND

In the context of the present invention, “long fibers” are spunbonded fabrics in which the fiber length can go to infinity, or are such fibers which are substantially longer, for example, approximately by an order of magnitude, than short fibers. The long fibers may have a length, for example, of between 10 and 150 mm. The long fibers can be selected from the group of artificial and/or synthetic fibers, in particular from viscose, polyester, polypropylene, polyamide, polyacrylic, polyvinyl alcohol and polyethylene fibers, as such or as a mixture thereof. It is also possible to use natural fibers as long fibers, for example, those selected from the group of cotton, hemp, flax, jute, or bamboo fibers, as such or as a mixture thereof, also with those from the group of the artificial and/or synthetic fibers. Long fibers made of biopolymers, for example, polyactide or polyhydroxybutyrate, can also be used, as such or as a mixture thereof, with those from the group of artificial and/or synthetic fibers and/or natural fibers.

The short fibers can accordingly have lengths in the range from 0.2 to 9 mm, depending on the lengths of the long fibers. They can in particular be selected from the group of natural fibers, in particular from fibrous material, also called pulp, recycling fibers, such as waste paper, and artificially produced fibers, as such or as a mixture thereof.

Such composite nonwoven webs can in particular be produced by the first layer comprising the long fibers, also referred to as “C layer,” being provided in line, i.e., in one and the same production line, initially via a carding unit, also called a “carding machine,” onto which the second layer comprising the short fibers is then applied. This can in particular take place with the aid of a headbox system via which the short fibers, in particular in the form of an aqueous dispersion, are dispensed onto the upper face of the first layer between two edges over a width extending transversely to the front direction. For this purpose, the headbox system may in particular comprise what is referred to as a “headbox” via which the amount of fibers or aqueous dispersion per time unit required for the desired properties of the second layer is dispensed onto the surface of the first layer over a width delimited by two edges.

The first layer may, however, also have been produced offline, i.e., in a separate production line and provided with the device for producing a composite nonwoven web for applying the second layer.

For transporting the first layer in the conveying direction, a conveyor device is provided which, among other things, may comprise a circulating screen belt with an upper run on which the first layer to be provided rests. The second layer may be dispensed onto the upper face of the first layer via the headbox system, in particular the headbox. Downstream therefrom, in the conveying direction, the first and second layers are then compacted, for example, via a hydroentanglement device.

A disadvantage of such a device is that the width of the second layer, i.e., its extension transverse to the conveying direction between its edges, because of its structure, cannot be changed without adversely affecting the fluid dynamics, in particular when using a hydraulic headbox. A cutting off of the excess width at one or both lateral edges of the composite nonwoven web after compaction of the two layers is therefore considered in particular for a change in width of the composite nonwoven web.

This feature for adjusting the width of the composite nonwoven web is, however, disadvantageous because the cut off edge regions, due to the compaction of the long fibers with the short fibers, are only sent for disposal, and the long fibers and short fibers cannot be reused separately from one another and, for example, be fed back to the production process.

### SUMMARY

An aspect of the present invention is therefore to further develop a device for producing a composite nonwoven web of the type mentioned above so that a change in the width of the composite nonwoven web is possible while maintaining reusability, for example, by recycling at least the short fibers that are cut off.

In an embodiment, the present invention provides a device for producing a composite nonwoven web which comprises at least a first layer and a second layer. The first layer comprises at least one of a spunbonded nonwoven and long fibers. The first layer is arranged to comprise an upper face and a first width. The second layer comprises short fibers and is arranged to have a second width. The device includes at least one conveyor device which is configured to transport at least the first layer in a conveying direction, a headbox system which is configured to dispense the short fibers onto the upper face of the first layer between two edges which extend transversely to the conveying direction, and a collecting device which is configured so that some of the short fibers dispensed from the headbox system can be collected in a region of at least one of the two edges before the short fibers which are dispensed in the region come into contact with the upper face of the first layer.

### BRIEF DESCRIPTION OF THE DRAWINGS

The present invention is described in greater detail below on the basis of embodiments and of the drawings in which:

FIG. 1 shows the exemplary embodiment of the device according to the present invention in a side view;

FIG. 2 shows a side view of an assembly with a headbox and with a first exemplary embodiment of a collecting device in a first operating state;

FIG. 3 shows the same assembly in the same view in a second operating state;

FIG. 4 is a plan view of the same assembly according to FIG. 2;

FIG. 5 is a side view of an assembly with a headbox and a second exemplary embodiment of a collecting device in a first operating state;

FIG. 6 shows the same assembly in the same view in a second operating state;

FIG. 7 is a plan view of the same assembly according to FIG. 5;

FIG. 8 shows a third exemplary embodiment of a collecting device in a plan view according to FIG. 5;

FIG. 9 shows a first view of the collecting chamber of the collecting device according to FIG. 8;

FIG. 10 shows a second view of the collecting chamber of the collecting device according to FIG. 8;

FIG. 11 shows a third view of the collecting chamber of the collecting device according to FIG. 8;

FIG. 12 shows a fourth view of the collecting chamber of the collecting device according to FIG. 8;

FIG. 13 shows a first view corresponding to FIG. 9 of a further embodiment of the collecting chamber;

FIG. 14 shows a second view corresponding to FIG. 10 of a further embodiment of the collecting chamber;

FIG. 15 shows a third view corresponding to FIG. 11 of a further embodiment of the collecting chamber; and

FIG. 16 shows a fourth view corresponding to FIG. 12 of a further embodiment of the collecting chamber.

### DETAILED DESCRIPTION

The device according to the present invention comprises at least one conveyor device for transporting at least the first layer in a conveying direction and a headbox system in particular with a hydraulic headbox, for dispensing the short fibers, in particular in the form of an aqueous dispersion, between two edges over a width extending transversely to the conveying direction. The device according to the present invention further comprises a collecting device via which a part of the short fibers dispensed from the headbox can be collected in the region of at least one of the two edges before the short fibers come into contact with the upper face of the first layer. The width of the second layer, also called the second width, is thereby reduced without affecting the application properties of the headbox, for example, its fluid dynamics. The collected short fibers can then be gathered separately and provided for recycling or returned to the ongoing manufacturing process. Should the second width of the second layer be smaller than the first width of the first layer, in other words have width regions projecting beyond the first layer after the dispensing of the short fibers, they can be cut off in any way and the long fibers can in turn be collected separately and provided for further use or returned to the running production process.

In an embodiment of the device according to the present invention, the collecting device can, for example, comprise at least one collecting chamber, which has an inlet opening on the side facing the headbox and an inflow edge against which the short fibers dispensed from the headbox flow, which inflow edge is formed by a partition wall. The partition wall is oriented and arranged so that it cuts off the region of the width by the short fibers being collected during operation of the device from the region of the width in which the short fibers are dispensed onto the upper face of the first layer during operation of the device. In other words, the partition wall produces an edge of the second layer.

The partition wall may, for example, be designed as a surface element with an inner surface and an outer surface so that the inner surface extends at least in regions in the conveying direction or at an angle thereto and perpendicular or at an angle to the upper face of the first layer. This feature produces a sharp cutoff of the collected short fibers from the short fibers dispensed onto the upper face of the first layer and thus a well-defined edge of the second layer. The partition wall can, for example, also be curved or formed by a part of a pipe wall. If the collecting device comprises two collecting chambers, wherein the short fibers that are discharged from the headbox can be collected in the region of the one edge via the one collecting chamber and in the region of the other edge via the other collecting chamber, the second layer with a second width predetermined by the positions of the partition walls and with well-defined edges can, for example, be dispensed onto the upper face of the first layer.

If at least one of the collecting chambers is arranged displaceably in the width direction, the second width of the second layer can, for example, be changed without the production process having to be interrupted or the device having to be modified at all.

An embodiment of the device according to the present invention provides that at least one of the collecting chambers can, for example, comprise a base inner wall with a surface section which, when viewed in the conveying direction, ascends, for example, continuously, and then descends, for example, discontinuously, in particular in a stepped manner, in relation to the upper face of the first layer. It has surprisingly been shown that due to this feature, the fibers can be collected without an undesirable fiber buildup occurring in the collecting chamber, and that an undesired backflow of the fibers from the collecting chamber is at the same time effectively prevented.

In an embodiment of the device according to the present invention, the collecting chamber can, for example, be curved in plan view, for example, approximately around a quarter circle. This embodiment is characterized by particularly good flow properties which in particular prevent a backflow of the collected short fibers dispensed from the headbox from occurring in the collecting chamber.

The collecting chamber can, for example, comprise, at the end remote from its inlet opening, a transition region in which at least the base, for example, also the cover, is formed sloping downwards, for example, curved downwards, for example, approximately parallel to one another. Due to this feature, the flow properties of the collecting chamber are further improved because the flow of the short fibers also drops downward. The transition region can, for example, open into a downwardly directed funnel with a neck to which a pipeline can be connected via which the flow of the short fibers can be fed to a conditioning device.

In a further development of the device according to the present invention, the headbox can, for example, be arranged to be pivotable about a pivot axis extending approximately parallel to the upper face of the first layer and approximately transversely to the conveying direction. As a result of this feature, parameters under which the short fibers impinge on the upper face of the first fiber, such as the point of incidence, the angle of incidence, and the impact rate, can vary depending on fiber properties and desired properties of the composite nonwoven web.

In a first variant of a development of the device according to the present invention, the collecting chamber is firmly joined (with the exception of displaceability in the width direction of the composite nonwoven) to the headbox web. As a result of this feature, the conditions under which short fibers discharged from the headbox flow into the at least one collecting chamber do not change when the headbox is pivoted about the pivot axis, and a sealing between the base inner wall and the headbox can be accomplished in a simple manner in order to prevent fibers from escaping in undesirable width ranges on the upper face of the first layer.

It is disadvantageous, however, that when the headbox is pivoted about the pivot axis, the flow direction in which the short fibers flow into the collecting chamber changes relative to the upper face of the first layer. It cannot thus be ruled out that the short fibers must flow in an ascending manner relative to the upper face, which increases the risk of a backflow of the short fibers that creates congestion in the collecting chamber. When the headbox is pivoted, the distance of the collecting chamber from the upper face of the first layer also changes, which can likewise negatively influence the production process of the composite nonwoven web.

In another variant of a development of the device according to the present invention, the at least one collecting chamber is therefore arranged independently of the headbox so that a pivoting of the headbox about the pivot axis does not lead to a displacement of the base inner wall relative to the upper face of the first layer. This embodiment of the device according to the present invention therefore requires a separate device, for example, an auxiliary frame, for the arrangement of the at least one collecting chamber which results in an increased design effort. It is, however, advantageous that the at least one collecting chamber is adjustable in height in a position-variable manner relative to the headbox, in particular relative to the upper face of the first layer, and can furthermore, for example, be displaced parallel to the upper face of the first layer and thus be arranged optimally adapted to the respective process parameters.

In a development of the device according to the present invention, the collecting chamber can, for example, be arranged to be pivotable about an approximately vertical axis so that the partition wall can be brought into an orientation in which it forms a clearance angle which opens with respect to the conveying direction. It has surprisingly been found that a clearance angle reduces a tendency of impinging short fibers dispensed from the headbox to adhere to the inflow edge, and this already at a small clearance angle. The maximum pivot angle, and accordingly the clearance angle, is therefore, for example, 10°, for example, 5°, and, for example, 3.5°.

The collecting chamber can be designed so that the vertical axis passes through the base of the collecting chamber approximately perpendicularly and in the width direction, for example, approximately centrally between the partition wall and a side wall which is opposite the partition wall and delimits the collecting chamber.

The formation of the clearance angle is accompanied by an oblique position of the lower edge of the entry opening of the collecting chamber so that the distance of the lower edge from the headbox to its side edge decreases. Because the speed of the flow of the short fibers to the side edges of the headbox decreases due to friction on the respective side wall, the distance reduction results in a reduction in the amount of short fibers which can undesirably reach the first layer through a gap between the lower edge of the entry opening and the headbox.

In an embodiment of the device according to the present invention, the collecting device can, for example, comprise a return device with which collected short fibers can be indirectly or directly returned to the headbox system. The term “indirectly returnable” can be understood to mean, for example, that the collected short fibers are rinsed out of the collecting chamber using additional liquid to facilitate removal and possibly further transport from the collecting chamber. Due to the use of a rinsing liquid, a treatment step is then required before the short fibers are returned into the process.

“Immediately returnable” is to be understood as meaning that the collected short fibers are returned to the production process without any further treatment, as a result of which the effort associated with the production process is reduced compared to the indirect return. In the simplest case, only one flow meter, which measures the returned quantity of collected short fibers, is required, whereas, in contrast, in the case of an indirect return, at least the density of short fibers in the dispersion is additionally detected and the return must be carried out in a controlled manner with respect to the fiber density.

In an embodiment, the device according to the present invention can, for example, comprise a cleaning device via which the inflow edge of the partition wall can be cleaned. This is because it has been shown that, during operation of the device, short fibers accumulate on this edge, which can lead to an influencing of the second width of the second layer and to a decline in the quality of the respective edge of the second layer. The cleaning device can, for example, be designed so that the cleaning of the inflow edge takes place continuously. The cleaning device may for this purpose comprise a gas nozzle which, during the production operation, is impinged with pressurized gas, in particular with compressed air. The short fibers accumulated on the inflow edge are then continuously blown off, which has the disadvantage that an increased effort must be made to avoid an uncontrolled spreading thereof in the surroundings.

In a second variant, the cleaning device comprises, instead of the gas nozzle, a liquid nozzle which is continuously impinged with a liquid, in particular water, under excess pressure during operation of the device, so that any short fibers accumulated on the inflow edge are rinsed off. This embodiment reduces the risk of an undesirable scattering of short fibers into the environment compared to a blowing off with, for example, compressed air. The additional cleaning liquid does, however, require an additional processing of the short fibers for the purpose of returning them into the production process.

In order to reduce the amount of short fibers which accumulate on the inflow edge, devices for separating the material stream emerging from the headbox, such as baffles, etc., can be provided.

The short fibers collected via the collecting device can, for example, be gathered in a bed or in a standpipe, and can be added continuously to the production process.

An exemplary embodiment of a device according to the present invention will be explained in greater detail below under reference to the drawings.

The exemplary embodiment of the device according to the present invention, which is designated as a whole by 100 in the drawings, comprises a manufacturing line 1 which, viewed in a conveying direction 2 one behind the other, has a first region 3 for forming a first layer 4, a second region 5 for forming a second layer 6, a third region 7 for compacting the first layer 4 and the second layer 6 to form a composite nonwoven web 8, and a fourth region 9 for finishing and winding the composite nonwoven web 8.

The device 100 furthermore comprises a conveyor device 10, the components of which include a deflecting roller 11 provided in the first region 3, a screen belt 12 provided in the second region 5 and, running around four deflecting rollers 18, a deflecting roller 13 provided in the third region 7, and a winding device 14 provided in the fourth region 9. The conveyor device 10 serves to transport the first layer 4 and the second layer 6 and the composite nonwoven web 8 formed therefrom in the conveying direction 2.

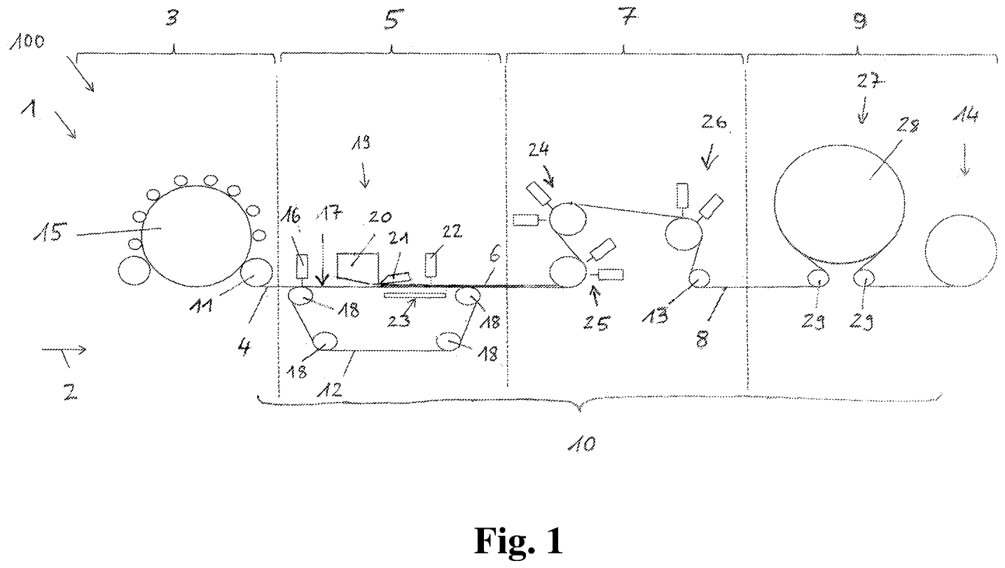

The device 100 shown in FIG. 1 has in its first region 3 a carding unit 15 of a known design for providing the first layer 4 comprising the long fibers.

The first layer 4 is pre-consolidated with the aid of a pre-consolidation apparatus 16, which is provided in the conveying direction 2 at the beginning of an upper run 17, which forms the working run, of the screen belt 12.

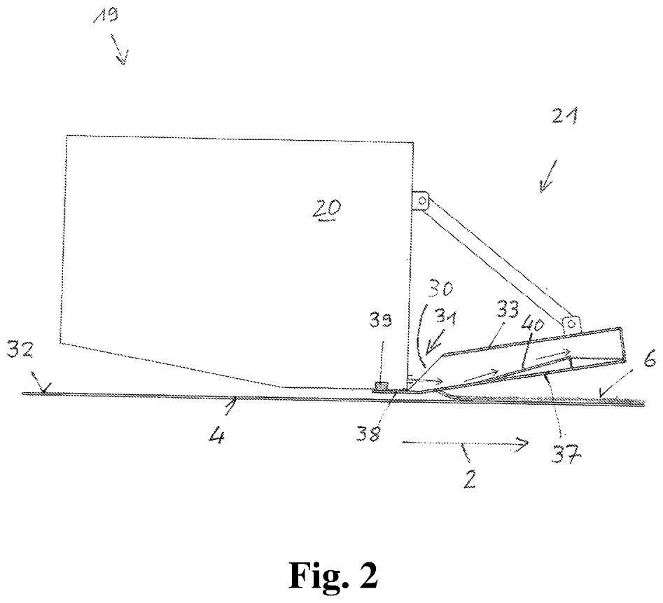

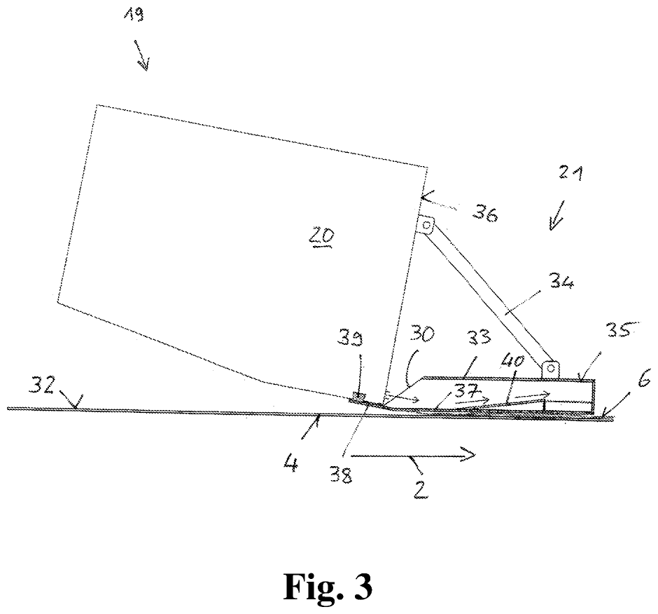

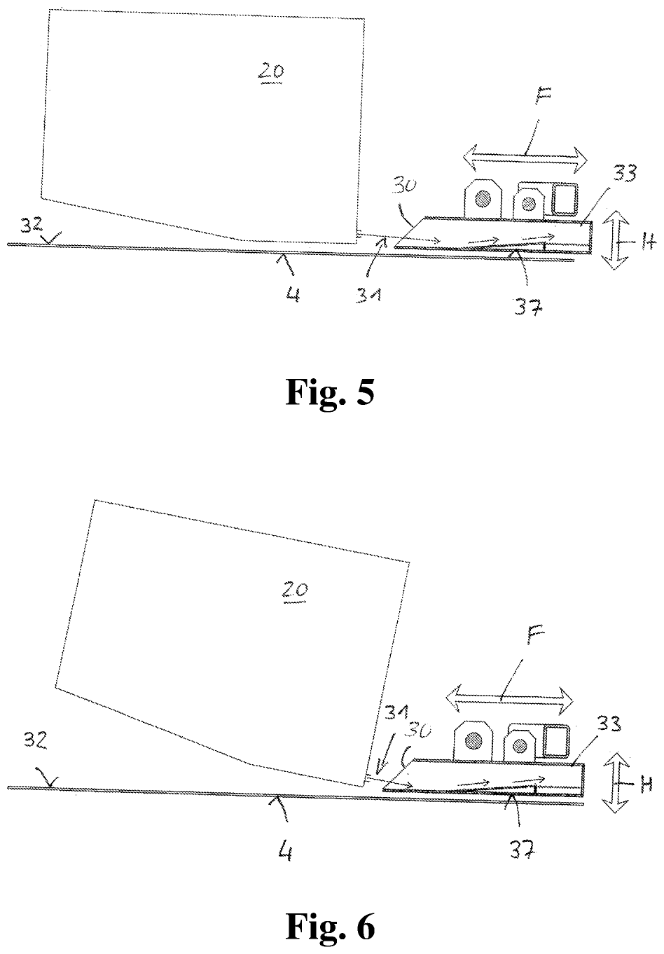

A headbox system 19 is provided downstream from the pre-consolidation apparatus 16, as seen in the conveying direction 2, the headbox system 19 comprising a headbox 20 which serves to dispense an aqueous dispersion containing the short fibers between edges R1 and R2 to form the second layer 6 on the first layer 4. A collecting device 21 is arranged downstream of the headbox 20, as seen in the conveying direction 2. Details of exemplary embodiments of the headbox 20 and the collecting device 21 are explained in more detail below with reference to FIGS. 2 to 7.

A further pre-consolidation apparatus 22 is provided downstream of the headbox 20 and the collecting device 21, as seen in the conveying direction 2, the further pre-consolidation apparatus 22 serving for the pre-consolidation of the second layer 6. Below the upper run 17 of the screen belt 12, as seen in the conveying direction 2, a water pickup 23 is provided downstream of the headbox 20 with which water of the dispersion and, if the further pre-consolidation apparatus 22 is a hydroentanglement device, water discharged therefrom is collected and removed.

The third region 7 of the device 100 comprises three compacting devices 24, 25, 26, which can in turn be designed as hydroentanglement devices and which serve for compaction, i.e., the connection of the second layer 6 to the first layer 4 to form the composite nonwoven web 8.

The fourth region 9 comprises a drum dryer 27. The drum dryer 27 comprises a drum 28 around which the composite nonwoven web 8 is guided via two deflecting rollers 29. Downstream of the drum dryer 27, in the conveying direction 2, the composite nonwoven web 8 is wound up via the aforementioned winding device 14.

FIGS. 2 to 4 schematically show a first exemplary embodiment of an assembly comprising the headbox 20 and the collecting device 21. The headbox system 19 comprises the headbox 20, which serves for the dispensing of the short fibers in the form of the aqueous dispersion 31 between the edges R1 and R2.

The collecting device 21 is provided downstream of the headbox 20 in the conveying direction 2. It comprises a collecting chamber 33, also called a “catch box,” which in the first exemplary embodiment illustrated in FIGS. 2 to 4, is fixedly joined to the headbox with the exception of the possible displacement in a width direction B running transversely to the conveying direction 2. The stabilization of this connection is served in particular by a strut 34 which connects a cover 35 of the collecting chamber 33 to an approximately vertical wall 36 of the headbox 20.

The collecting chamber 33 has a lower base 37 which comprises a region 38 that extends up to below the headbox 20 and rests against it via a guide arrangement 39.

A surface section 40 is provided on the sides of the base 37, which surface section when viewed in the conveying direction 2, ascends continuously in relation to the upper face 32 of the first layer 4, and then descends in a stepped manner.

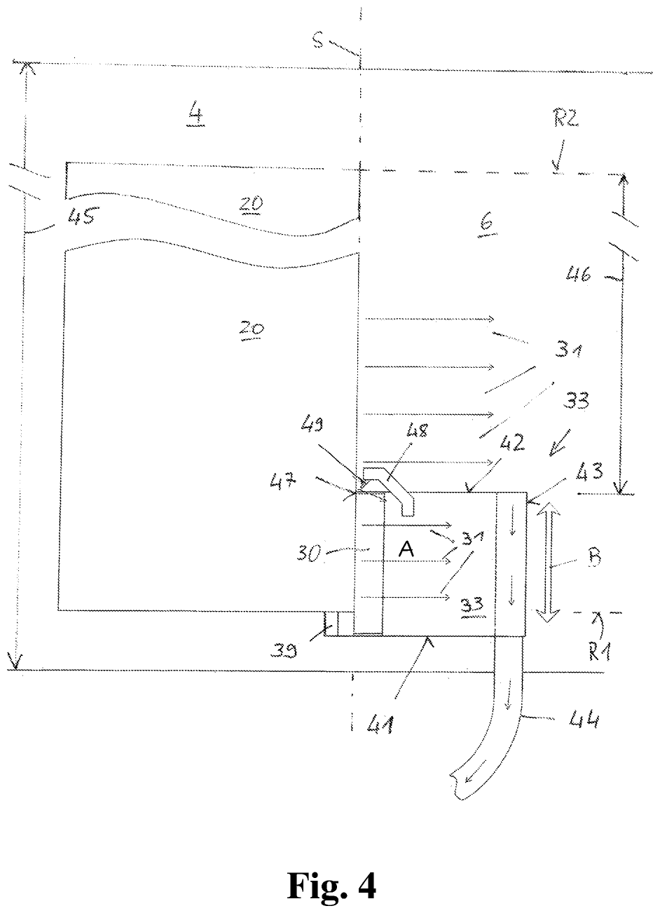

As can in particular be seen in FIG. 4, the collecting chamber 33 comprises an outer side wall 41 and an opposite partition wall 42 which, together with the cover 35, the base 37, and a rear wall 43, delimit the collecting chamber 33. The side of the collecting chamber facing the headbox 20 forms an inlet opening 30 for a part of the aqueous dispersion 31 dispensed from the headbox 20. As can in particular be seen in FIG. 4, this is the part of the total dispensed aqueous dispersion 31 which is dispensed in an edge region determined by the position of the collecting chamber 33 in the width direction B. The portion of the aqueous dispersion 31 which is dispensed above from the headbox 20 according to FIG. 4, i.e., in the operating position of the device 100 next to the outer side of the partition wall 42, reaches the upper face 32 of the first layer 4, whereas the portion of the aqueous dispersion 31 which according to FIG. 4 is dispensed below, i.e., in the operating position of the device 100 next to the inner side of the partition wall 42, is collected by the collecting chamber 33 before it comes into contact with the upper face 32 of the first layer 4. This portion can thus be fed to the aqueous dispersion, for example, via a pipeline 44 of a conditioning device (which is not shown in the drawings) or a device (which is likewise not shown in the drawing) for feeding the headbox 20 with the aqueous dispersion.

FIG. 4 shows a first layer 4 with a first width 45. As can further be seen from FIG. 4, the second width 46 of the second layer 6 can be changed by displacing the collecting chamber 33 in the width direction B. A critical factor for the second width 46 is the respective positioning of the partition wall 42, the edge of which facing the headbox 20 forms an inflow edge 47 against which the aqueous dispersion flows during operation of the device.

A cleaning device 48 is provided in order to be able to clean short fibers accumulated on the inflow edge 47 during operation of the device. The cleaning device 48 comprises a gas or liquid nozzle 49 via which gas, in particular air or liquid, in particular water, can be applied to the inflow edge.

As shown in FIG. 4, it is understood that a collecting device 21, for example, in the form of the shown collecting chamber 33, can be provided not only on a lateral edge region of the headbox 20, but also on the opposite edge region, in order to thus be able to influence the second width 46 of the second layer 6 from both edges.

A further exemplary embodiment of an assembly comprising the headbox 20 and the collecting device 21 is shown in FIGS. 5 to 7, which correspond to FIGS. 2 to 4. To avoid repetition, only the differences from the first exemplary embodiment shown in FIGS. 2 to 4 will be explained below.

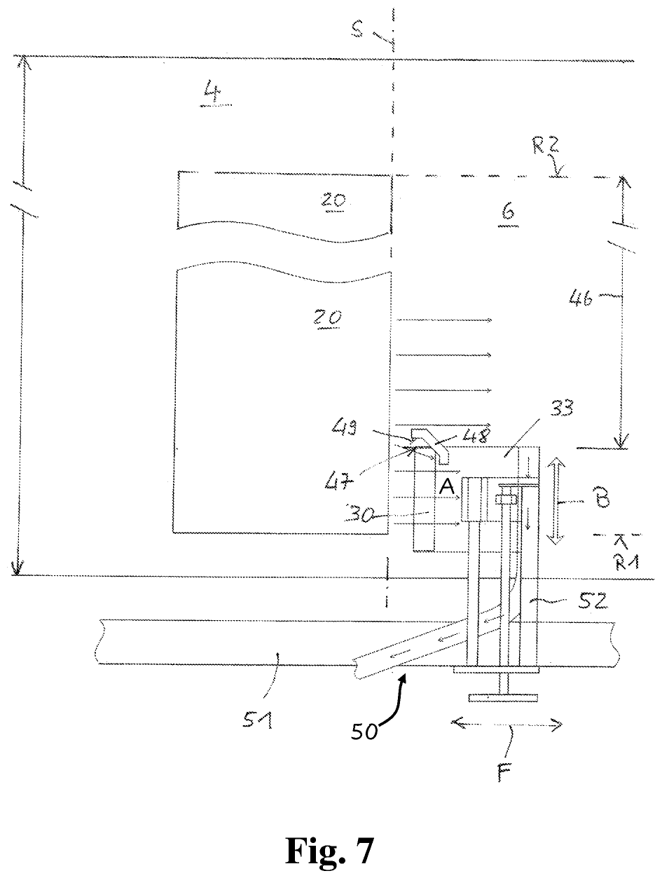

In contrast to the first exemplary embodiment, the collecting chamber 33 in this embodiment is not mechanically joined to the headbox 20, but is instead mounted separately from the headbox 20 using an auxiliary frame 50. The collecting chamber 33 can therefore be held with its base 37 parallel to the first layer 4 regardless of the angular position of the headbox 20 relative to the upper face 32 of the first layer 4. The collecting chamber 33 can furthermore be displaced independently of the headbox 20 in the vertical direction H perpendicular to the upper face 32 and in the direction F, namely in and counter to the conveying direction 2. For this purpose, the auxiliary frame 50 shown in FIG. 7 comprises a first guide arrangement 51 extending in the direction F, along which a second guide arrangement 52 can be displaced in the F direction, on which the collecting chamber 33 is in turn arranged displaceably in the width direction B.

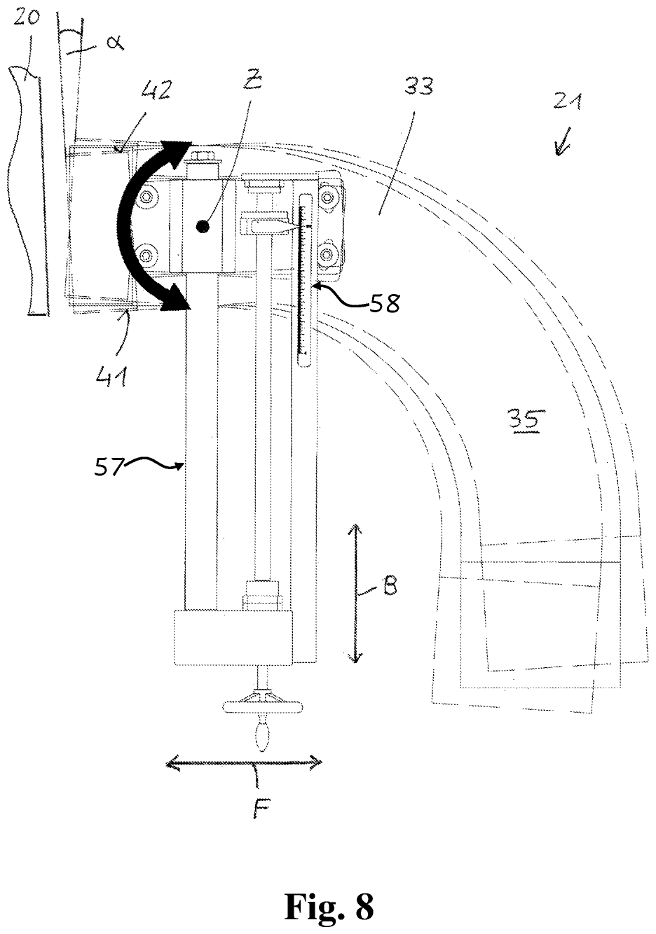

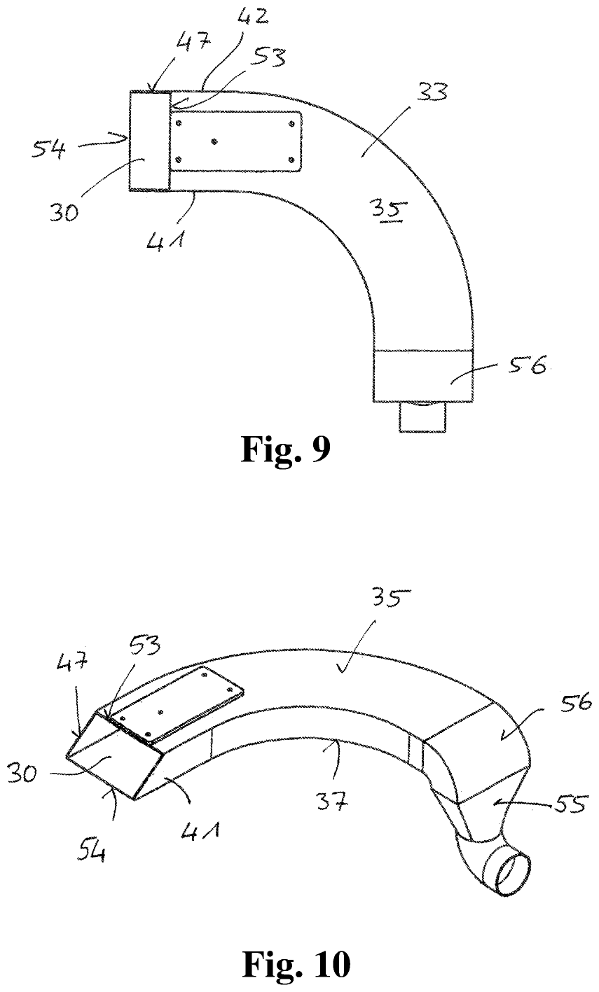

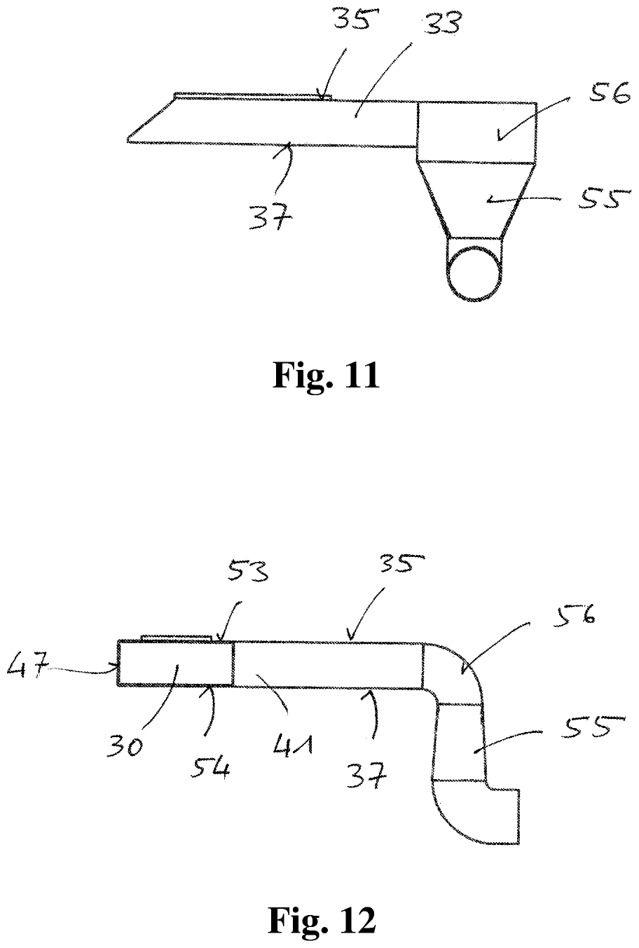

FIG. 8 shows a third exemplary embodiment of a collecting device 21 in which the collecting chamber 33 is not mechanically joined to the headbox 20. Various views of an exemplary embodiment of a collecting chamber 33 of this exemplary embodiment are illustrated separately in FIGS. 9 to 12. To avoid repetition, only the differences from the second exemplary embodiment illustrated in FIGS. 5 to 7 will be explained below.

In contrast to the second exemplary embodiment, the collecting chamber 33 is arranged so as to be pivotable independently of the headbox 20 about an axis Z, which is oriented approximately perpendicular to the width direction B and to the direction F, i.e., it runs approximately in the vertical direction H. Axis Z passes through the cover 35 and the base 37 of the collecting chamber 33 approximately perpendicular in the width direction B approximately centrally between the outer side wall 41 and the partition wall 42.

In the shown embodiment, the maximum pivot angle α about the axis Z is 3.5°.

Due to this pivotable arrangement, which is illustrated graphically in FIG. 8, it is possible to align the collecting chamber 33 so that the upper edge 53 and the lower edge 54 of the inlet opening 30 do not run from the headbox 20 perpendicularly to the dispensing direction A of the aqueous dispersion 31, but rather obliquely thereto, and flows against the inflow edge 47 of the inlet opening 30, likewise obliquely.

The collecting chamber 33 is curved by a corresponding design of the cover 35 and its base 37 in plan view over a quarter circle. This avoids turbulence of the flow of the removed short fibers which could lead to an obstruction within the collecting chamber.

The collecting chamber 33 comprises a downwardly directed funnel 55 at the end which is remote from the entry opening. The cover 35 and the base 37 are curved downward approximately parallel to one another in a transition region 56 in order to reduce turbulence of the flow and to avoid a backflow of the short fibers in the transition region 56.

The pipeline 44 is connected to the funnel 55 during operation, via which the removed short fibers can be fed to a conditioning device.

For controllable adjustment of the second width 46 of the second layer 6, the collecting chamber 33 in the third embodiment is provided on a spindle-actuated linear adjuster 57 which comprises a scale 58 for the optical detection of the position of the collecting chamber 33 in the width direction B.

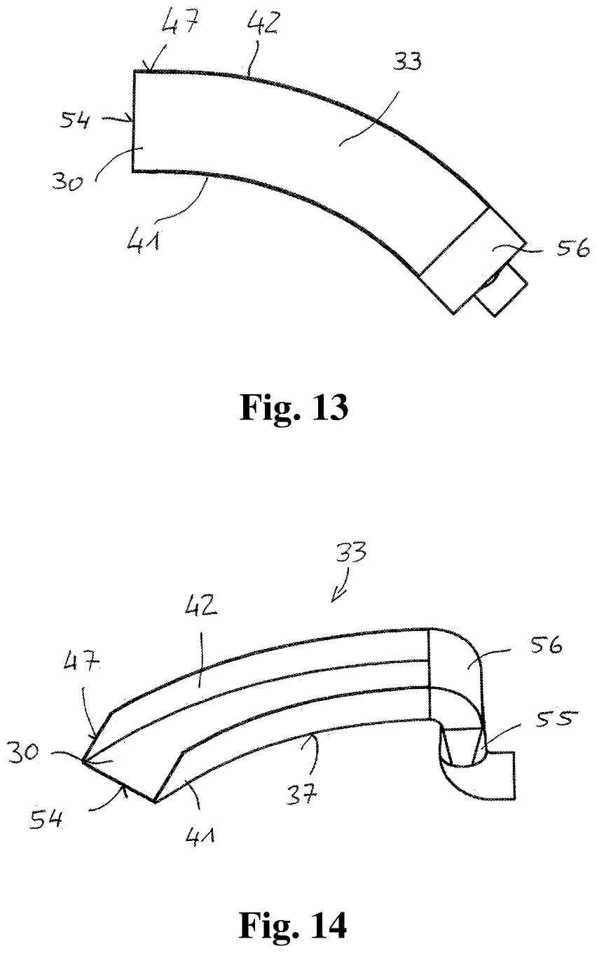

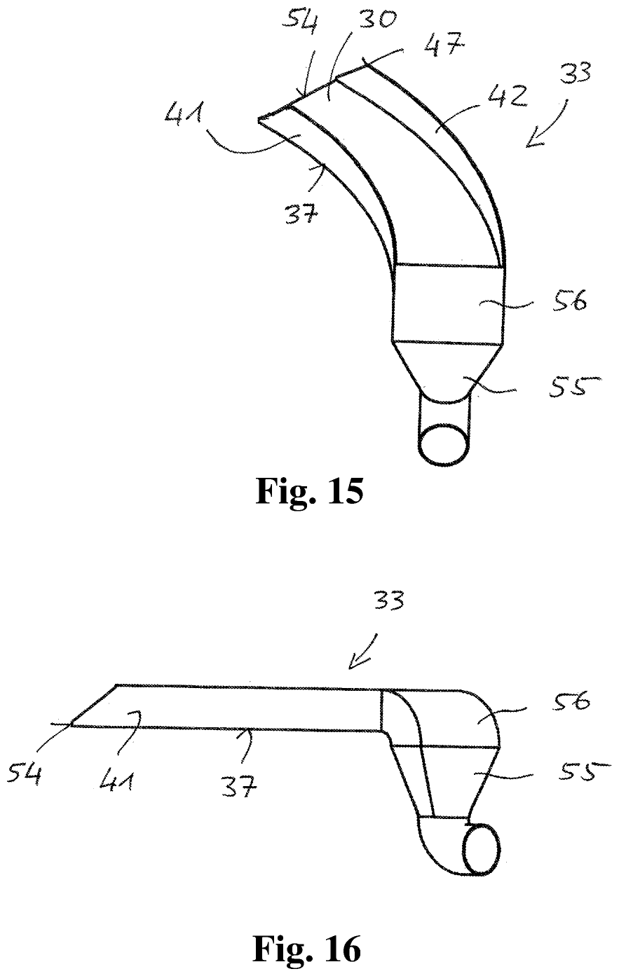

A fourth exemplary embodiment of a collecting chamber 33 is shown in FIGS. 13 to 16. To avoid repetition, only the differences from the third exemplary embodiment illustrated in FIGS. 9 to 12 are explained below. Reference is also made to the above statements regarding the third exemplary embodiment.

In the fourth exemplary embodiment, the collecting chamber 33 is curved by a corresponding formation of its base 37 in plan view only around one eighth of a circle with a larger radius of curvature. This further reduces the flow resistance of the removed short fibers. The fourth exemplary embodiment of the collecting chamber 33 also does not comprise a cover, whereby the manufacturing outlay is reduced and cleaning is facilitated.

The present invention is not limited to embodiments described herein; reference should be had to the appended claims.

### LIST OF REFERENCE SIGNS

100 device
1 manufacturing line
2 conveying direction
3 first region
4 first layer
5 second region
6 second layer
7 third region
8 composite nonwoven web
9 fourth region
10 conveyor device
11 deflecting roller
12 screen belt
13 deflecting roller
14 winding device
15 carding unit
16 pre-consolidation apparatus
17 upper run
18 deflecting rollers
19 headbox system
20 headbox
21 collecting device
22 further pre-consolidation apparatus
23 water pickup
24 compacting device
25 compacting device
26 compacting device
27 drum dryer
28 drum
29 deflecting rollers
30 inlet opening
31 aqueous dispersion
32 upper face
33 collecting chamber
34 strut
35 cover
36 wall
37 base
38 region
39 guide arrangement
40 surface portion
41 outer side wall
42 partition wall
43 rear wall
44 pipeline
45 first width
46 second width
47 inflow edge
48 cleaning device
49 nozzle
50 auxiliary frame
51 first guide arrangement
52 second guide arrangement
53 upper edge
54 lower edge
55 funnel
56 transition region
57 linear adjuster
58 scale
α pivot angle
A dispensing direction (of the aqueous dispersion 31)
B width direction
F direction (along which the second guide arrangement 52 can be
displaced)
H vertical direction
R1 edge
R2 edge
S pivot axis
z axis

What is claimed is:

1-15. (canceled)

16: A device for producing a composite nonwoven web which comprises at least a first layer and a second layer, the first layer comprising at least one of a spunbonded nonwoven and long fibers, the first layer being arranged to comprise an upper face and a first width, and the second layer comprising short fibers and being arranged to have a second width, the device comprising:
at least one conveyor device which is configured to transport at least the first layer in a conveying direction;
a headbox system which is configured to dispense the short fibers onto the upper face of the first layer between two edges which extend transversely to the conveying direction; and
a collecting device which is configured so that some of the short fibers dispensed from the headbox system can be collected in a region of at least one of the two edges before the short fibers which are dispensed in the region come into contact with the upper face of the first layer.

17: The device as recited in claim 16, wherein,
the collecting device comprises at least one collecting chamber which comprises an inlet opening,
the inlet opening is delimited by a partition wall which comprises an inflow edge against which the short fibers which have been dispersed flow, and
the partition wall is configured to cut off a width of the region in which the short fibers are collected during an operation of the device from a width of a region in which the short fibers are discharged onto the first layer during the operation of the device so that a position of the partition wall affects the second width of the second layer.

18: The device as recited in claim 17, wherein the partition wall is provided as a planar element which comprises an inner wall and an outer wall, the partition wall being further configured so that the inner wall extends at least in some regions in the conveying direction and perpendicular to the upper face of the first layer.

19: The device as recited in claim 17, wherein,
the at least one collecting chamber of the collecting device is provided as a first collecting chamber and a second collecting chamber,
the first collecting chamber is configured so that the short fibers dispensed by the headbox system in the region of a first edge of the two edges can be collected, and
the second collecting chamber is configured so that the short fibers dispensed by the headbox system in the region of a second edge of the two edges can be collected.

20: The device as recited in claim 19, wherein at least one of the first collecting chamber and the second collecting chamber is/are arranged so as to be displaceable in a width direction.

21: The device as recited in claim 19, wherein at least one of the first collecting chamber and the second collecting chamber comprises a base which comprises a surface section which, when viewed in the conveying direction, ascends and descends in relation to the upper face of the first layer.

22: The device as recited in claim 21, wherein the surface section ascends continuously, and then descends discontinuously in a stepped manner, in relation to the upper face of the first layer, respectively.

23: The device as recited in claim 17, wherein the at least one collecting chamber has a curved design when viewed from above.

24: The device as recited in claim 23, wherein the at least one collecting chamber further comprises a downwardly directed funnel at an end which is remote from the inlet opening.

25: The device as recited in claim 24, wherein,
the at least one collecting chamber further comprises a base, and
the base is arranged to slope downward in a transition region to the downwardly directed funnel.

26: The device as recited in claim 17, wherein,
the headbox system comprises a headbox which is pivotably arranged about a pivot axis which extends approximately parallel to the upper face of the first layer and approximately transversely to the conveying direction, and
the at least one collecting chamber is fixedly joined to the headbox in a width direction with the exception of a displaceability relative to the headbox.

27: The device as recited in claim 17, wherein,
the headbox system comprises a headbox, and
the at least one collecting chamber is configured so as to be displaceable independently of the headbox.

28: The device as recited in claim 27, wherein the at least one collecting chamber is configured so as to be displaceable independently of the headbox in at least one of a height-adjustable manner relative to the upper face of the first layer and parallel to the upper face of the first layer in or counter to the conveying direction.

29: The device as recited in claim 27, wherein,
the at least one collecting chamber further comprises a base, and a side wall which is opposite to the partition wall,
the at least one collecting chamber is further configured to be pivotable by a pivot angle about a vertical axis, and
the vertical axis passes through the base of the at least one collecting chamber approximately perpendicularly and, in a width direction, approximately centrally between the partition wall and the side wall.

30: The device as recited in claim 29, wherein the pivot angle has a maximum of 10°.

31: The device as recited in claim 17, further comprising:
a cleaning device which is configured to clean the inflow edge.

32: The device as recited in claim 31, wherein the cleaning device comprises a gas nozzle or a liquid nozzle.

33: The device as recited in claim 16, wherein the collecting device comprises a return device via which the short fibers which have been collected can be indirectly or directly returned to the headbox system.
